(19) United States
(12) Patent Application Publication
(10) Pub. No.: US 2026/0160671 A1
(43) Pub. Date: Jun. 11, 2026

(54) CORROSION RESISTANT CUVETTE ADAPTER

(71) Applicant: Wyatt Technology, LLC, Goleta, CA (US)

(72) Inventors: Ryan Patrick McGuan, Santa Barbara, CA (US); Howard Friedenberg, Santa Barbara, CA (US); Siddharth Sood, Ventura, CA (US)

(21) Appl. No.: 19/410,354

(22) Filed: Dec. 5, 2025

Related U.S. Application Data
(60) Provisional application No. 63/728,801, filed on Dec. 6, 2024.

(51) Int. Cl. G01N 21/09; G01N 21/47; G01N 21/51

(52) U.S. Cl. CPC G01N 21/09; G01N 21/47; G01N 2021/513

(57) ABSTRACT

Disclosed is a cuvette adapter that includes a body with a chamber for receiving a cuvette and a plurality of openings on an exterior of the body. A plurality of disks are plated with a corrosion-resistant material, and each respective disk of the plurality of disks is positioned in a respective opening of the plurality of openings on the exterior of the body. The disks are configured for providing electrical contact between the cuvette adapter and a light scattering instrument. A system and method for detecting a cuvette adapter are also disclosed.

### RELATED APPLICATION

This application claims priority to U.S. Provisional Ser. No. 63/728,801 filed on Dec. 6, 2024 and titled “Corrosion Resistant Cuvette Adapter” the entirety of which is incorporated herein by reference.

### FIELD OF THE INVENTION

The invention relates generally to cuvette adapters. Cuvette adapters may be used with a variety of cuvettes to hold a sample for a light scattering instrument. More particularly, the invention relates to a corrosion resistant cuvette adapter providing improved detection, recognition, and/or identification by light scattering instruments.

### BACKGROUND

Light scattering instruments are used to measure properties of particles in a sample. Dynamic, electrophoretic, and/or static light scattering may be used depending on the specific light scattering instrument. As examples, size, molecular weight, distribution, concentration, zeta potential, and other properties may be measured.

Samples provided to the light scattering instrument are often held in a cuvette as discussed for example, in US Patent Publication No. US 2023/0115994, the entire contents of which are hereby incorporated by reference. As discussed therein, a cuvette containing a sample may be positioned in a receptacle in the light scattering instrument.

A cuvette adapter is often provided to allow for a variety of cuvettes to be used with a single light scattering instrument. The cuvette and the cuvette adapter may be referred to together as a cell.

In order to properly analyze the sample, it is often important that the light scattering instrument both properly detect and properly recognize/identify the cell, i.e., the light scattering instrument should properly detect, recognize, and identify the cuvette adapter and/or the cuvette. Proper detection, recognition, and/or identification is often impeded by mechanical wear and/or corrosion of the cuvette adapter.

Thus, cuvette adapters that provide for improved wear resistance, corrosion resistance, and detection would be well received in the art.

### SUMMARY

In one embodiment, a cuvette adapter comprises a body, the body having a chamber for receiving a cuvette and a plurality of openings on an exterior of the body, and a plurality of disks plated with a corrosion-resistant material, wherein each respective disk of the plurality of disks is positioned in a respective opening of the plurality of openings on the exterior of the body, wherein the disks are configured for providing electrical contact between the cuvette adapter and a light scattering instrument.

Additionally or alternatively, each respective disk of the plurality of disks is press-fit into the respective opening of the plurality of openings.

Additionally or alternatively, each respective disk of the plurality of disks protrudes from the body when positioned in the respective opening of the plurality of openings.

Additionally or alternatively, the plurality of openings on the exterior of the body extend through a thickness of the body.

Additionally or alternatively, each disk of the plurality of disks comprises an electrically conductive material.

Additionally or alternatively, the electrically conductive material is a metal.

Additionally or alternatively, the electrically conductive metal comprises brass.

Additionally or alternatively, the corrosion-resistant material is resistant to oxidation.

Additionally or alternatively, the corrosion-resistant material is a metal.

Additionally or alternatively, the metal is a noble metal.

Additionally or alternatively, the metal is selected from the group consisting of gold, platinum, silver, nickel-tin, and silver-tin.

Additionally or alternatively, the light scattering instrument is for electrophoretic light scattering measurement.

In another embodiment, a system comprises a light scattering instrument having a receptacle and an electric contact proximate the receptacle, a cuvette adapter configured to be positioned within the receptacle, the cuvette adapter having a body with a chamber for receiving a cuvette, a first opening on the body, a second opening on the body, a first disk positioned in the first opening, and a second disk positioned within the second opening, wherein the first disk and the second disk are configured to contact the electric contact of the light scattering instrument.

Additionally or alternatively, the first disk is press-fit into the first opening and/or the second disk is press-fit into the second opening.

Additionally or alternatively, the first disk and/or the second disk protrude from the body.

Additionally or alternatively, the first disk and the second disk comprise an electrically conductive material plated with a corrosion-resistant material.

Additionally or alternatively, the corrosion-resistant metal is a noble metal.

In a further embodiment, a method of detecting a cuvette adapter comprises providing a light scattering instrument having a receptacle and an electric contact proximate the receptacle, providing a cuvette adapter, the cuvette adapter having a body with a chamber for receiving a cuvette, a first opening on the body, a second opening on the body, a first disk positioned in the first opening, and a second disk positioned within the second opening, positioning the cuvette adapter within the receptacle, such that the first disk and the second disk contact the electric contact, and detecting the cuvette adapter.

Additionally or alternatively, detecting the cuvette adapter includes detecting an electric short between the first disk and the second disk.

Additionally or alternatively, the first disk is press-fit into the first opening and/or wherein the second disk is press-fit into the second opening.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1A depicts a schematic front perspective view of a conventional cuvette adapter.

FIG. 1B depicts a schematic front view of the conventional cuvette adapter of FIG. 1A.

FIG. 2 depicts a schematic view of a light scattering system for use with a cuvette adapter and a cuvette.

FIG. 3 depicts a cell identification circuit diagram.

FIG. 4A depicts a graph showing errors in reading a cell using a conventional cuvette adapter.

FIG. 4B depicts another graph showing errors in reading another cell using another conventional cuvette adapter.

FIG. 5A depicts a schematic front perspective view of a corrosion resistant cuvette adapter in accordance with embodiments of the present invention.

FIG. 5B1 depicts a schematic side view of the corrosion resistant cuvette adapter of FIG. 5A.

FIG. 5B2 depicts an enlarged portion of the schematic side view of the corrosion resistant cuvette adapter of FIG. 5B1.

FIG. 5C depicts a schematic side perspective view of the corrosion resistant cuvette adapter of FIGS. 5A, 5B1, and 5B2.

FIG. 6A depicts a graph showing errors in reading a cell using a conventional cuvette adapter after a galvanic corrosion study.

FIG. 6B depicts a graph showing proper reading of a cell using a corrosion resistant cuvette adapter according to embodiments of the present invention after a galvanic corrosion study.

FIG. 7 depicts a method for detecting a cuvette adapter and/or a cell using a cuvette adapter in accordance with embodiments of the present invention.

### DETAILED DESCRIPTION

Reference in the specification to “one embodiment” or “an embodiment” means that a particular, feature, structure, or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

In brief overview, the invention relates to light scattering instruments and cuvette adapters for use in light scattering instruments. The present invention provides cuvette adapters, systems, and methods that provide improved detection of the cuvette adapter and/or a cell including the cuvette adapter by the light scattering instrument. Further, the present invention provides cuvette adapters, systems, and methods that provide increased reliability in detection and identification of the cuvette adapter by the light scattering instrument.

### Current Technologies

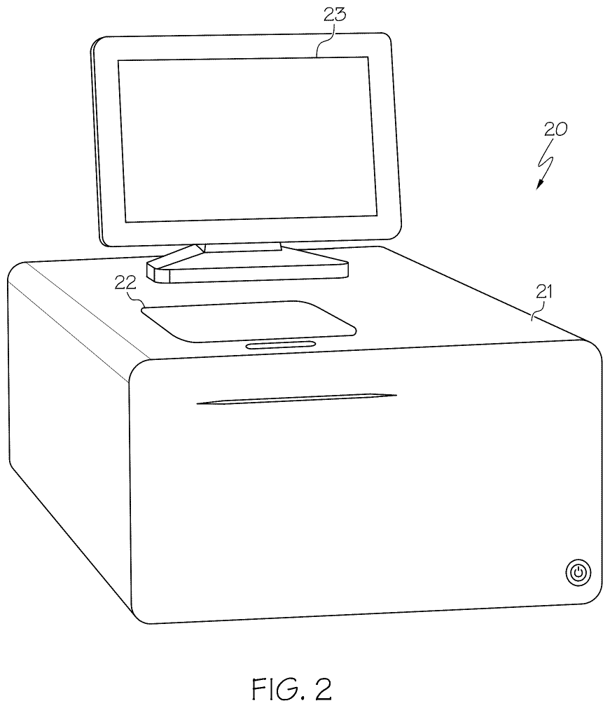

As discussed above, cuvette adapters are often provided to allow for a variety of cuvettes to be used with a light scattering instrument (for example, light scattering instrument 20 shown in FIG. 2 and discussed in more detail below). For example, cuvette adapters may allow for users to provide samples in proprietary and/or non-proprietary cuvettes. Likewise, general purpose and/or special purpose cuvettes may be used depending on the sample to be tested and/or measurements to be performed. Still further, different types of cuvettes and/or cuvettes made of different materials may be used as needed or desired. The presence of a cuvette adapter and/or a cell having a cuvette adapter and a cuvette may be detected by the light scattering instrument, for example, by one or more electrical contacts and/or electrical shorts as explained in more detail below.

Samples are often prepared in corrosive solvents such as salt water, toluene, etc. Such solvents may spill on the cuvette adapter, for example, during transport to or from the receptacle, in the receptacle, or at other points. Further, electrolytic solutions may be used at various times. The presence of water, salts, and other corrosive elements can corrode the cuvette adapters, leading to problems in detecting, recognizing, and/or identifying the cell, the cuvette adapter and/or the cuvette by the light scattering instrument. For example, the cuvette adapter may become corroded. Additionally or alternatively, the presence of the water, salts, or other corrosive elements can create contact resistance interfering with the light scattering instrument's ability to detect, recognize, and/or identify the cell, the cuvette adapter, and/or the cuvette. Additionally or alternatively, general wear on the cuvette adapter may lead to problems in detecting, recognizing, and identifying the cell, the cuvette adapter, and/or the cuvette by the light scattering instrument.

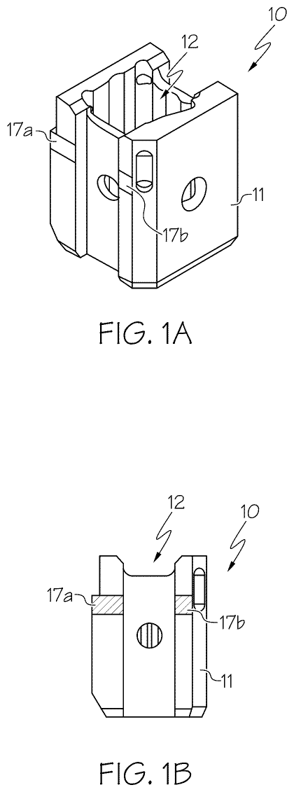

By way of example, current technologies include conventional cuvette adapters such as those depicted in FIG. 1A and FIG. 1B. As shown therein, a conventional cuvette adapter 10 includes a body 11 and a chamber 12 for receiving a cuvette (not shown). The conventional cuvette adapter 10 may be formed of aluminum or other material; specifically, the body 11 may consist or comprise of aluminum or other material. The conventional cuvette adapter 10 and/or the body 11 may be formed of anodized aluminum or other material. The conventional cuvette adapter 10 may include contact points, for example, a first contact point 17a and a second contact point 17b. The contact points 17a, 17b may be formed by an un-anodized area of the conventional cuvette adapter 10 and/or the body 11. For example, the conventional cuvette adapter 10 and/or the body may have the contact points 17a, 17b masked during an anodization process, resulting in the un-anodized area. The un-anodized area may thus consist or comprise exposed aluminum or other material as opposed to the anodized aluminum or other material. The un-anodized area and/or the contact points 17a, 17b may have a coating, for example, a chem film coating. The chem film coating may also be applied to the rest of the body 11, for example, portions of, or the entirety of, the body 11 may have chem film applied followed by anodization (except in masked areas).

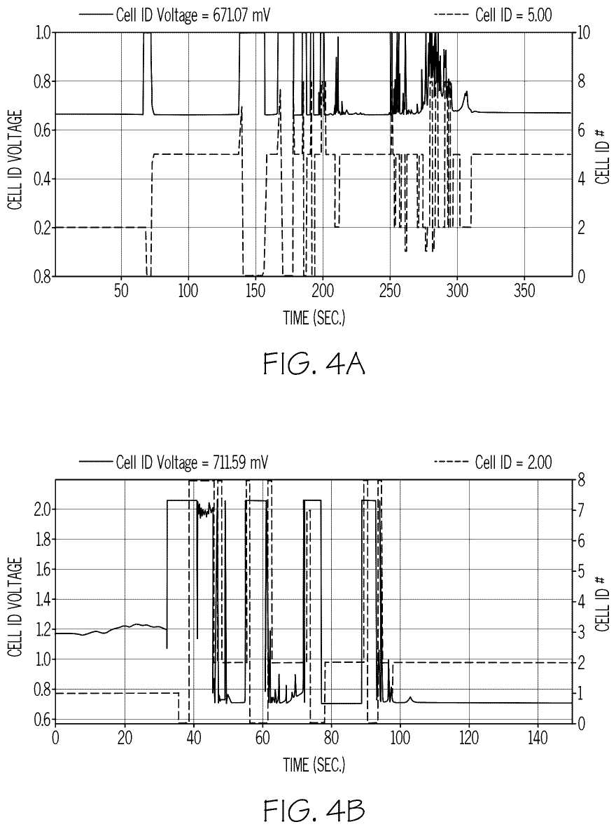

The un-anodized area, for example, the contact points 17a, 17b may allow for electrical contact with a component (not shown) of the light scattering instrument such as the light scattering instrument 20 of FIG. 2, for example, with one or more corresponding contact points of the light scattering instrument 20. For example, the contact points 17a, 17b may contact an electrical contact such as electrical contact 25 shown in FIG. 4C.

Over time, the contact points 17a, 17b may experience mechanical wear, corrosion, and other degradation.

For example, as the conventional cuvette adapter 10 is used, i.e., is repeatedly placed into the light scattering instrument 20 and removed from the light scattering instrument 20, the conventional cuvette adapter 10 may undergo mechanical wear. The mechanical wear may result in degradation of the chem film coating, degradation of the aluminum or other material, and the like.

Additionally or alternatively, as discussed above, samples used in cuvettes placed in the conventional cuvette adapter 10 are often prepared in corrosive solvents such as salt water, toluene, etc., and spills often occur. Further, electrolytic solutions may be used in connection with the light scattering instrument 20, the conventional cuvette adapter 10, and/or a cell. The presence of water, salts, and other corrosive elements can corrode the conventional cuvette adapter 10, for example, degrading the chem film, corroding the un-anodized aluminum or other material, and the like. This corrosion leads to problems in detecting, recognizing, and/or identifying the conventional cuvette adapter 10, a cuvette, and/or a cell by the light scattering instrument 20. Additionally or alternatively, the presence of water, salts, or other corrosive elements can create contact resistance on the conventional cuvette adapter 10, the body 11, and/or the contact points 17a, 17b, interfering with the light scattering instrument's ability to detect, recognize, and/or identify the conventional cuvette adapter 10, cuvette, and/or cell.

Turning to FIG. 2, an exemplary light scattering instrument 20 is shown. The light scattering instrument 20 may be of a type known in the conventional art and/or may include features of a conventional system or device. For example, the light scattering instrument 20 may be of any type known in the art, including but not limited to an instrument for dynamic, electrophoretic, and/or static light scattering. As shown, the light scattering instrument 20 may have a receptacle 22 for receiving a cuvette and/or a cuvette adapter holding a cuvette, i.e., for receiving a cell. The light scattering instrument may also include a body 21, a user interface 23, and other components.

It will be understood that the light scattering instrument 20 further includes at least one processor, controller, or the like. The at least one processor, controller, or the like may be positioned within or proximate to the body 21, the user interface 23, or at another location in the light scattering instrument 20. Further, an external processor, controller, or the like may be used. In embodiments, the at least one processor, controller, or the like may be configured for detecting a cuvette adapter as discussed in more detail herein.

### Cuvette Adapter Detection, Recognition, and Identification

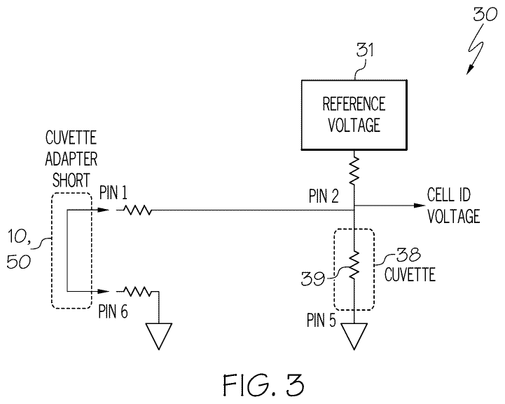

A cell and an accompanying cuvette adapter such as the conventional cuvette adapter 10 (or a corrosion resistant cuvette adapter such as the corrosion resistant cuvette adapter 50 discussed below) may be identified by a light scattering instrument such as the light scattering instrument 20 using a cell identification detection circuit such as cell identification detection circuit 30 that shown in FIG. 3. The cell identification detection circuit 30 may also be referred to as a voltage divider circuit.

As shown, a reference voltage 31 is provided. As an example, the reference voltage may be 2.048 V.

The cuvette adapter 10, 50 contacts pins of the cell identification detection circuit 30, for example, Pin 1 and Pin 6 as shown in FIG. 3. Based on the contact, an electrical connection is provided through the cuvette adapter 10, 50. For example, as shown in FIG. 3, a short (cuvette adapter short) may be formed. It will be understood that in some embodiments, a short may not be created and the circuit may instead be open. Other electrical connections may also be provided, for example, a resistance value. For example, different electrical connections, or lack thereof, may result depending on a type of cuvette adapter used and/or depending on an identity of a specific cuvette adapter.

A cuvette itself, for example cuvette 38 shown in FIG. 3, also contacts the cell identification circuit 30 when included in the cuvette adapter. For example, as shown, the cuvette 38 contacts pins of the cell identification circuit 30, for example, Pin 2 and Pin 5. Based on the contact, an electrical connection is provided through the cuvette 38. For example, as shown in FIG. 3, the cuvette 38 may have a resistance 39. It will be understood that in some embodiments, other electrical connections may also be provided.

Based on the provided reference voltage 31, the electrical connection through the cuvette adapter 10, 50 (for example, short, open, or resistance), and the electrical connection of the cuvette 38 (for example, resistance), a cell identification voltage is output, for example, to the light scattering instrument 20.

The cell identification voltage is used to identify the cell, for example to identify the cuvette adapter 10, 50, the cuvette 38, and/or the combination thereof. For example, the cell identification voltage may be compared with a nominal/reference cell identification voltage (for example, a list of nominal/reference cell identification voltages) to determine the presence and identity of the cuvette adapter and/or the cuvette. For example, the cell identification voltage may be compared with a table of nominal/reference cell identification voltages wherein each nominal/reference cell identification voltage is matched with a cell identification number. The cell identification number may be matched with a cuvette type, a cuvette feature, a cuvette model, a specific cuvette, a cuvette adapter type, a cuvette adapter feature, a specific cuvette adapter model, and the like. For example, a lookup table comprising cuvette types, cuvette features, cuvette models, specific cuvettes, cuvette adapter types, cuvette adapter features, specific cuvette adapter models, and the like may be used. As examples of cuvette types, features, models, etc., a cuvette may be a quartz cuvette, a disposable cuvette, a reusable cuvette, a flowcell, a dipcell, and the like.

It will be understood that a presence of the cuvette adapter may sometimes be required in order to properly identify a cell and/or a cuvette. However, conventional cuvette adapters that are worn, degraded, and/or corroded as discussed above often result in a cell identification voltage that is noisy, unreliable, and/or defective. Examples of cell identification voltage resulting from a worn, degraded, and/or corroded conventional cuvette adapter such as the conventional cuvette adapter 10 are shown in FIGS. 4A and 4B.

In FIG. 4A, a cell (containing a cuvette and a conventional cuvette adapter) that should have an expected nominal/reference cell identification voltage of approximately .66V when inserted and a cell identification number of 5 was provided. A user repeatedly inserted the cell into a light scattering instrument, removed the cell from the light scattering instrument, and/or contacted the cell while it was inserted into the light scattering instrument. These actions took place over a time span of several minutes. As shown in FIG. 4A, the resulting cell identification voltage varied from approximately 0.66V to over 1V and showed numerous fluctuations. Correspondingly, the cell identification number varied; while a proper cell identification number of 5 was output for some time periods, other time periods showed a cell identification number of 1, 2, and 8 over the time span. These errors were determined to be due to corrosion/wear of the conventional cuvette adapter.

In FIG. 4B, a cell (containing a cuvette and a conventional cuvette adapter) that should have an expected nominal/reference cell identification voltage of .7058V when inserted and a cell identification number of 2 was provided. A user repeatedly inserted the cell into and removed the cell from a light scattering instrument over a time span of several minutes. As shown in FIG. 4B, the resulting cell identification voltage varied from 0.6V to over 2V. Correspondingly, the cell identification number varied; while a proper cell identification number of 2 was output for some time periods, other time periods showed a cell identification number of 7 or 8. Again, these errors were determined to be due to corrosion/wear of the conventional cuvette adapter.

FIGS. 4A and 4B depict how a corroded cuvette adapter can cause unreliable detection, recognition, and identification of a cell, cuvette adapter, and/or a cuvette. Unreliable detection, recognition, and identification of the cell, cuvette adapter, and/or cuvette lead to malfunctions and failures in sample processing and/or errors in reported results from the light scattering system.

### Corrosion Resistant Cuvette Adapter

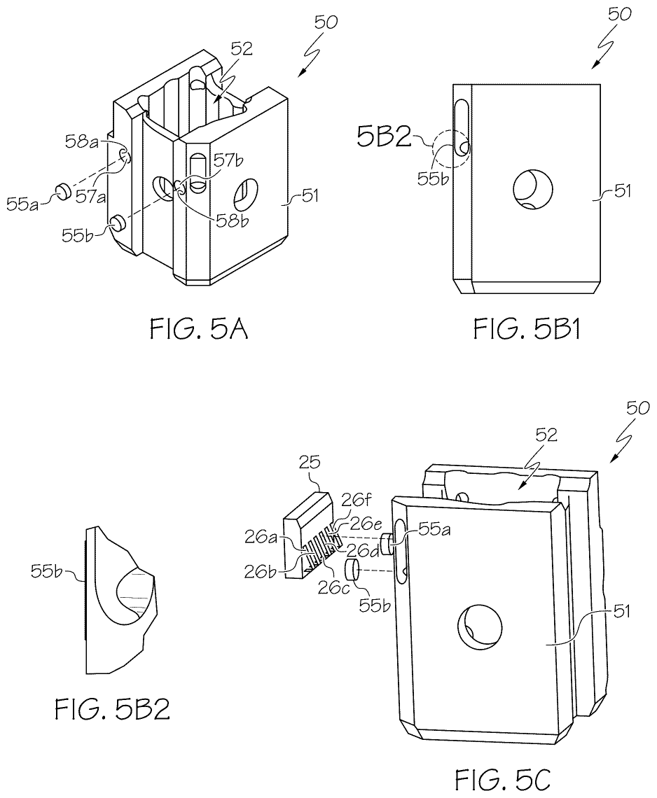

Referring now to FIGS. 5A-5C, embodiments of a corrosion resistant cuvette adapter 50 are shown.

As shown, for example, in FIG. 5A, the corrosion resistant cuvette adapter 50 includes a body 51 and a chamber 52 for receiving a cuvette (not shown) such as cuvette 38. The corrosion resistant cuvette adapter 50 may be formed of aluminum or other material; specifically, the body 51 may consist of or comprise aluminum or other material. The corrosion resistant cuvette adapter 50 and/or the body 51 may be formed of aluminum or other material to which a chem film is applied and/or which is anodized.

The corrosion resistant cuvette adapter 50 further includes a plurality of openings such as a first opening 57a and a second opening 57b. In embodiments, additional openings may also be included, such that the plurality of openings includes three or more openings. In embodiments, the openings 57a, 57b are located on the body 51 of the corrosion resistant cuvette adapter 50. For example, the openings 57a, 57b are located on an exterior of the body 51. For clarity, the chamber 52 may be referred to as being located on or at an interior of the body 51. In embodiments, the openings 57a, 57b may be through-holes, i.e., may extend through the corrosion resistant cuvette adapter 50. Specifically, the openings 57a, 57b may extend through the body 51 of the corrosion resistant cuvette adapter 50. Thus, in embodiments, the openings 57a, 57b, may extend from an exterior of the body 51 to an interior of the body 51, i.e., to the chamber 52.

In embodiments, the openings 57a, 57b may be un-anodized. For example, in some embodiments, the body 51 or a portion of the body 51 may be anodized while the openings 57a, 57b are not anodized. As a more specific example, the body 51 may be anodized aluminum while the openings 57a, 57b are un-anodized aluminum. For example, cylindrical surfaces 58a, 58b of the openings 57a, 57b may be un-anodized. Still further, in embodiments the cylindrical surfaces 58a, 58b may have a chem film coating.

The corrosion resistant cuvette adapter 50 further includes a plurality of disks such as a first disk 55a and a second disk 55b. A respective disk is provided for each respective opening of the plurality of openings. Thus, the first disk 55a corresponds to and is provided for the first opening 57a and the second disk 55b corresponds to and is provided for the second opening 57b.

While the openings 57a, 57b and disks 55a, 55b are both shown to be circular, it will be understood that other shapes/dimensions may be used in embodiments. For example, in embodiments the openings 57a, 57b and/or the disks 55a, 55b may be oval, elliptical, polygonal, etc.

Further, while the first opening 57a is shown to be the same shape, size, and dimension as the second opening 57b, it will be understood that there may be variety in the plurality of openings, for example, the second opening 57b may have a different shape, size, and dimension than the first opening 57a. Likewise, while the first disk 55a is shown to be the same shape, size, and dimension as the second disk 55b, it will be understood that there may be variety in the plurality of disks, for example, the second disk 55b may have a different shape, size, and dimension than the first disk 55a.

In embodiments, the disks 55a, 55b comprise a corrosion-resistant material. For example, the corrosion-resistant material may be resistant to oxidation. In embodiments, the corrosion resistant material may be a metal. Specifically, the corrosion resistant material may be a noble metal in embodiments. For example, the corrosion resistant material may be selected from the group consisting of gold, platinum, silver, nickel-tin, and silver-tin in embodiments.

Still further, the disks 55a, 55b may comprise an electrically conductive material. The electrically conductive material may be a metal. As an example, the electrically conductive material may be brass.

In embodiments, the disks 55a, 55b may comprises the electrically conductive material and the corrosion-resistant material. For example, in embodiments, the corrosion-resistant material may be provided as a coating, plating, or other covering for the electrically conductive material. Still further, in embodiments the corrosion-resistant material and the electrically conductive material may be the same material.

As one specific example, in embodiments one or more of the plurality of disks may comprise a gold-plated brass disk. By way of explanation and without limiting the disclosure, the gold plating may provide corrosion resistance and oxidation resistance while still providing conductivity.

In embodiments, the plurality of disks may be press fit into the plurality of openings; for example, the first disk 55a may be press fit into the first opening 57a and/or the second disk 55b may be press fit into the second opening 57b.

In embodiments, the disks may optionally be sized to be slightly larger than the openings. In such embodiments, press fitting the disks into the openings may result in deformation of the disks, mechanical interface between the respective disk and the respective opening, and a close interference fit.

The press fit connection and/or close interference fit achieved by the disks may prevent intrusion of any sample, solvent, or other material into the openings. Thus, contact between the sample, solvent, or other material and the un-anodized material of the body is prevented. Further, the press fit connection and/or close interference fit achieved by the disks results in a good contact (physical and electrical contact) between the respective disk 55a, 55b and the respective cylindrical surfaces 58a, 58b of the respective opening 57a, 57b. This contact facilitates the electrical connections discussed above, for example, an electrical short through the cuvette adapter 50 in some embodiments.

As shown in FIG. 5B2, in embodiments the respective disks 55a, 55b may be slightly raised with respect to the body 51 of the corrosion resistant cuvette adapter 50 and/or may protrude from the body 51 of the corrosion resistant cuvette adapter 50. The protrusion of the disks may facilitate electrical contact between the disks 55a, 55b (and therefore the corrosion resistant cuvette adapter 50) and a light scattering instrument such as the light scattering instrument 20.

For example, as shown in FIG. 5C, in an embodiment the light scattering instrument may comprise an electrical contact 25. The electrical contact 25 may include, for example, electrically conductive pins, springs, or the like. As an example and referring still to FIG. 5C, in embodiments the electrical contact 25 may include electrically conductive spring pins 26a, 26b, 26c, 26d, 26e, and 26f. It will be understood that one or more of the pins 26a-26f may form pins of the cell identification detection circuit 30 of FIG. 3 such as Pins 1, 2, 5, and 6 discussed above. Protrusion of the disks may facilitate contact between the disks and one or more of the electrically conductive spring pins 26a-26f when the corrosion resistant cuvette adapter 50 is positioned within the light scattering instrument 20. In embodiments, the protrusion of the disks may also help facilitate removal of any dirt or other build up, whether on the electrical contact 25 or on the disks themselves.

Referring again to FIG. 5B2, the protrusion is exaggerated for the purposes of visualization in the figure, and it will be understood that the protrusion may be quite small. Further, a specific protrusion is not required, and the protrusion may vary depending on the corrosion resistant cuvette adapter used, the light scattering instrument used, and other factors. In embodiments, the protrusion may be approximately 0.03 mm. In embodiments, a variation of 0.1 mm may be used. It will also be understood that in some embodiments no protrusion may be used, i.e., the respective disks may be positioned to be flush with the respective opening and/or with the body. Still further, it will be understood that in some embodiments, the respective disks may be positioned to be recessed into the respective opening and/or into the body 51.

Referring again to FIG. 5C, in embodiments, the electrical contact 25 (for example, one or more of the electrically conductive spring pins 26a-26f) may comprise gold. For example, the electrical contact 25 may be a gold contact and/or may be a gold-plated contact. Thus, in embodiments, gold disks or gold-plated disks 55a, 55b may provide a gold-to-gold contact between the corrosion resistant cuvette adapter 50 and the light scattering instrument 20.

In addition to excellent contact, corrosion resistance, and oxidation resistance, the corrosion resistant cuvette adapter also prevents galvanic corrosion as shown in Example 1.

### Example 1—Galvanic Corrosion Study

Galvanic corrosion was tested in a conventional cuvette adapter (such as the conventional cuvette adapter 10 of FIGS. 1A and 1B) and in a corrosion resistant cuvette adapter (such as the corrosion resistant cuvette adapter 50 of FIGS. 5A-5C).

A gold-plated contact (such as the electrical contact 25 of FIG. 5C) was affixed to the conventional cuvette adapter. The conventional cuvette adapter used in this example had contact points (such as contact points 17a, 17b) formed by an un-anodized area of an aluminum body.

A gold-plated contact (such as the electrical contact 25 of FIG. 5C) was affixed to the corrosion resistant cuvette adapter. The corrosion resistant cuvette adapter used in this example had disks (such as disks 55a, 55b) comprising gold and press fit into openings (such as openings 57a, 57b).

Both the conventional cuvette adapter and the corrosion resistant cuvette adapter were placed in a 50 mS/cm salt solution for 66 hours. Both the conventional cuvette adapter and the corrosion resistant cuvette adapter were then exposed to 8 V potential, drawing ˜20 mA for 15 seconds. This test may be understood to be a type of accelerated aging study, mimicking corrosion levels that would normally occur over an extended period of use.

After completion of the galvanic corrosion study, the conventional cuvette adapter had visible corrosion of the aluminum while no corrosion was visible on the corrosion resistant cuvette adapter.

Both the conventional cuvette adapter and the corrosion resistant cuvette adapter were then tested with a light scattering instrument such as the light scattering instrument 20 by being inserted into and removed from the receptacle of the light scattering instrument.

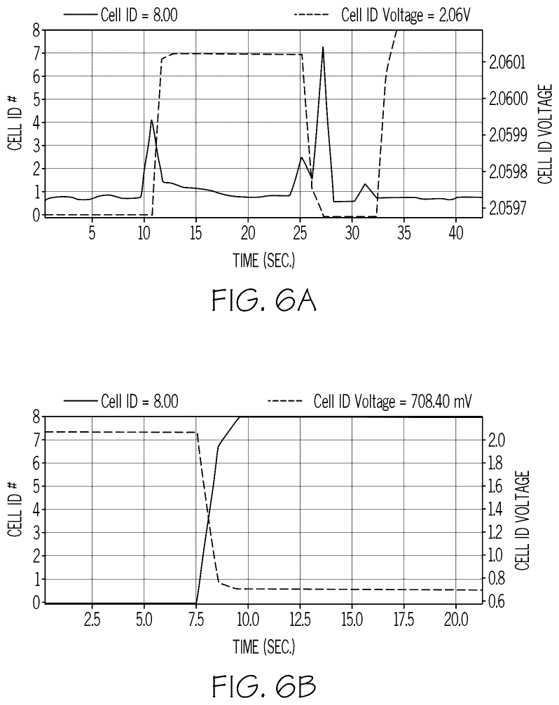

As shown in FIGS. 6A and 6B and discussed in more detail below, the light scattering instrument experienced problems properly detecting, recognizing, and identifying the conventional cuvette adapter while the corrosion resistant cuvette adapter was properly detected, recognized, and identified.

In FIG. 6A, the tested conventional cuvette adapter should have an expected nominal/reference cell identification voltage of 704 mV and a cell identification number of 8 when inserted (indicating a cell adapter without an accompanying cuvette). The tested conventional cuvette adapter was inserted into a light scattering instrument for a time span of approximately 30 seconds. As shown in FIG. 6A, the resulting cell identification voltage varied slightly but was consistently around 2.06 V (note the limited range of the voltage scale). At no time did the cell identification voltage reflect the expected drop down to the range of 700 mV. Correspondingly, the cell identification number varied; an improper cell identification number of 7 was output for much of the time span and other periods did not return any cell identification number (not detected, recognized, or identified).

In FIG. 6B, the tested corrosion resistant cuvette adapter should likewise have an expected nominal/reference cell identification voltage of 704 mV when inserted and a cell identification number of 8. The tested corrosion resistant cuvette adapter was inserted into a light scattering instrument for a time span of approximately fourteen seconds. As shown in FIG. 6B, after insertion of the corrosion resistant cuvette adapter, the resulting cell identification voltage quickly moved to and stabilized at 708.4 mV, well within an expected range of variation around 704 mV. Correspondingly, a proper cell identification number of 8 was output with no variation or change, showing proper detection, recognition, and identification of the corrosion resistant cuvette adapter.

In summary, FIG. 6A depicts another example of how aging, wear, and tear of a conventional cuvette adapter leads to unreliable detection, recognition, and identification of the conventional cuvette adapter, a cell, and/or a cuvette, while FIG. 6B shows improved resistance to aging, wear, and tear of a corrosion resistant cuvette adapter according to embodiments and continued reliable performance.

### Method

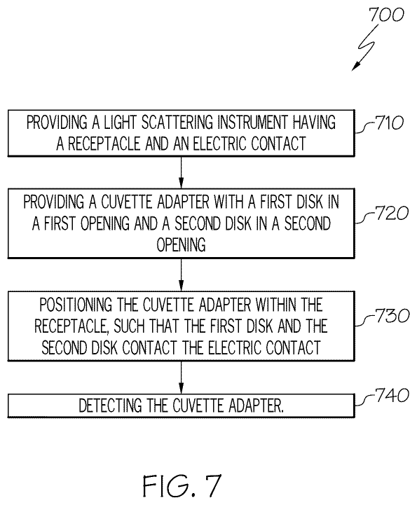

FIG. 7 depicts a method 700 for detecting a cuvette adapter (or a cell) in accordance with embodiments of the present invention. The method 700 is an exemplary method and may be varied according to the embodiments described herein.

The method 700 includes a step 710 of providing a light scattering instrument (such as the light scattering instrument 20) having a receptacle (such as receptacle 22) and an electric contact (such as electrical contact 25) proximate the receptacle.

The method 700 further includes a step 720 of providing a cuvette adapter (such as the corrosion resistant cuvette adapter 50). The cuvette adapter has a body (such as the body 51) with a chamber (such as the chamber 52) for receiving a cuvette, a first opening (such as the first opening 57a) on the body, a second opening (such as the second opening 57b) on the body, a first disk (such as the first disk 55a) positioned in the first opening, and a second disk (such as the second disk 55b) positioned within the second opening.

In embodiments, the method may also include a step of press fitting the first disk into the first opening and/or press fitting the second disk into the second opening.

The method 700 includes a step 730 of positioning the cuvette adapter within the receptacle. For example, the cuvette adapter may be positioned within the receptacle such that the first disk and/or the second disk contact the electrical contact.

The method 700 may also include a step 740 of detecting the cuvette adapter. In embodiments, the step of detecting the cuvette adapter may include detecting an electrical short between the first disk and the second disk.

In embodiments, the method may also include the step of detecting a cuvette and/or detecting a cell comprising the cuvette adapter and the cuvette. In embodiments, the method may include a step of receiving a cell identification voltage. Still further, in embodiments, the method may include a step of comparing the cell identification voltage with a nominal/reference cell identification voltage.

The flowchart diagram of FIG. 7 illustrates the steps of possible implementations of methods according to various embodiments of the present invention. It will be understood that features from the devices discussed above may be incorporated into the method in some embodiments. Further, in some implementations, the steps noted may occur out of the order noted in the figure and discussed above. For example, two steps shown in succession may, in fact, be executed substantially concurrently, or the steps may sometimes be executed in the reverse order, depending upon the functionality involved.

While the invention has been shown and described with reference to specific embodiments, it should be understood by those skilled in the art that various changes in form and detail may be made therein without departing from the spirit and scope of the invention as recited in the accompanying claims.

What is claimed is:

1. A cuvette adapter, comprising:
a body, the body having a chamber for receiving a cuvette and a plurality of openings on an exterior of the body; and
a plurality of disks plated with a corrosion-resistant material, wherein each respective disk of the plurality of disks is positioned in a respective opening of the plurality of openings on the exterior of the body;
wherein the disks are configured for providing electrical contact between the cuvette adapter and a light scattering instrument.

2. The cuvette adapter of claim 1, wherein each respective disk of the plurality of disks is press-fit into the respective opening of the plurality of openings.

3. The cuvette adapter of claim 1, wherein each respective disk of the plurality of disks protrudes from the body when positioned in the respective opening of the plurality of openings.

4. The cuvette adapter of claim 1, wherein the plurality of openings on the exterior of the body extend through a thickness of the body.

5. The cuvette adapter of claim 1, wherein each disk of the plurality of disks comprises an electrically conductive material.

6. The cuvette adapter of claim 5, wherein the electrically conductive material is a metal.

7. The cuvette adapter of claim 6, wherein the electrically conductive metal comprises brass.

8. The cuvette adapter of claim 1, wherein the corrosion-resistant material is resistant to oxidation.

9. The cuvette adapter of claim 1, wherein the corrosion-resistant material is a metal.

10. The cuvette adapter of claim 9, wherein the metal is a noble metal.

11. The cuvette adapter of claim 9, wherein the metal is selected from the group consisting of gold, platinum, silver, nickel-tin, and silver-tin.

12. The cuvette adapter of claim 1, wherein the light scattering instrument is for electrophoretic light scattering measurement.

13. A system, comprising:
a light scattering instrument having a receptacle and an electric contact proximate the receptacle;
a cuvette adapter configured to be positioned within the receptacle, the cuvette adapter having a body with a chamber for receiving a cuvette, a first opening on the body, a second opening on the body, a first disk positioned in the first opening, and a second disk positioned within the second opening, wherein the first disk and the second disk are configured to contact the electric contact of the light scattering instrument.

14. The system of claim 13, wherein the first disk is press-fit into the first opening and/or the second disk is press-fit into the second opening.

15. The system of claim 13, wherein the first disk and/or the second disk protrude from the body.

16. The system of claim 13, wherein the first disk and the second disk comprise an electrically conductive material plated with a corrosion-resistant material.

17. The system of claim 16, wherein the corrosion-resistant metal is a noble metal.

18. A method of detecting a cuvette adapter, comprising:
providing a light scattering instrument having a receptacle and an electric contact proximate the receptacle;
providing a cuvette adapter, the cuvette adapter having a body with a chamber for receiving a cuvette, a first opening on the body, a second opening on the body, a first disk positioned in the first opening, and a second disk positioned within the second opening;
positioning the cuvette adapter within the receptacle, such that the first disk and the second disk contact the electric contact; and
detecting the cuvette adapter.

19. The method of claim 18, wherein detecting the cuvette adapter includes detecting an electric short between the first disk and the second disk.

20. The method of claim 18, wherein the first disk is press-fit into the first opening and/or wherein the second disk is press-fit into the second opening.
